(19) United States
(12) Patent Application Publication
(10) Pub. No.: US 2010/0185600 A1
(43) Pub. Date: Jul. 22, 2010

(54) APPARATUS AND METHOD FOR INTEGRATION SEARCH OF WEB SITE

(76) Inventors: Han-Jin Shin, Gyeongsangbuk-do (KR); Se-Yub Kim, Gyeongsangbuk-do (KR)

Correspondence Address: SHERR & VAUGHN, PLLC, 620 HERNDON PARKWAY, SUITE 320, HERNDON, VA, 20170, US

(21) Appl. No.: 12/523,932

(22) PCT Filed: Jan. 22, 2008
(86) PCT No.: PCT/KR08/00393

§ 371 Date: Oct. 28, 2009

(30) Foreign Application Priority Data
Jan. 22, 2007 (KR) 10-2007-0006634

(51) Int. Cl. G06F 17/30

(52) U.S. Cl. 707/707; 707/E17.108; 707/706

(57) ABSTRACT

Disclosed is a web-site integration search method capable of consecutively searching a list of pre-registered search channels using a first keyword input by the user, even without inputting the first keyword in target search engines to be searched one by one. The method includes the steps of: inputting a first keyword in a keyword input window, and selecting one of multiple set search engines or all the set search engines; performing morpheme analysis of the input first keyword; generating a second keyword reconstructed through the morpheme analysis; adding an automatic execution instruction which sets the second keyword to be automatically input in an input window of the selected search engine; and receiving the second keyword, to which the automatic execution instruction has been added, transmitting the second keyword including the automatic execution instruction to a selected search engine through at least one output browser, and displaying searched information which is detected through the transmission.

### TECHNICAL FIELD

The present invention relates to a web site search system, and more particularly to an apparatus and method for an integration search of multilingual web sites using key word analysis and translation.

### BACKGROUND ART

The Internet has expanded faster than expected. The reason for this is that individuals as well as companies create homepages for public relations. A lot of people put matters of concern over various fields, such as art, literature, science, medicine, entertainment, sports, politics, technology, industry, economics or the like, in their home pages. Daily news ranging from the trivial to the professional, which is produced all over the world, is dealt with in news groups that are formed by people having the same concerns in each field.

As the contents of the Internet become various, the amount of information provided via the Internet increases like a rolling snowball. Accordingly, in order for a user to select desired information on the Internet that is fast growing, his/her own know-how is required, which is made possible by search engines (e.g. YAHOO, ALLIANZ, NAVER, EMPAS, PARAN, NATE, DAUM, GOOGLE, etc.).

The search engine refers to an Internet site that helps users to search numerous sites on the Internet for a site containing desired information. Several hundreds of search engines are present on the Internet.

Criteria for classifying search engines have not been officially established. However, the search engines are generally classified into subject-based search engines and keyword-based search engines according to the patterns of operations. The keyword-based search engines are classified into general keyword-based search engines, front-end type search engines, and intelligent search engines.

However, all the search engines are not classified clearly as described above. That is, a representative search engine of subject-based search engines, YAHOO, supports keyword-based search. The keyword-based search engines mostly support subject-based search as well as keyword-based search at the same time.

The subject-based search engines refer to search engines that provide lists in which information on the Internet is classified according to subjects such as society, culture, art, sports, politics or the like. The subject-based search engines are called directory servers, subject-based catalogues and menu search engines because they provide various information corresponding to each subject as a list. The subject-based search engines are advantageous in that they can easily approach corresponding information when an accurate topic word or keyword for a search for information cannot be selected, but disadvantageous in that there is danger that they may not approach the information by an erroneous intermediate step because they should go through various steps, such as main categories->intermediate categories->subcategories->desired information, until they approach the information.

The general keyword-based search engines refer to search engines in which homepage contents and Uniform Resource Locators (URLs; or homepage addresses) are arranged in their own databases. The general keyword-based search engines are advantageous in that desired information can be searched for only by inputting several keywords, but disadvantageous in that a large amount of time may be wasted because of the output of erroneous results when a keyword-based search is performed with an inaccurate keyword.

Since search engines use different data collection schemes, as described above, and the domain names or IP addresses of web sites registered in databases are frequently changed or withdrawn as time goes by, it is difficult for a communication user to search for all desired information through one search engine. For this reason, users generally use a plurality of search engines in order to search for information, and in this case, each user visits different search engines and repeatedly inputs the same keyword. Therefore, there is inconvenience in that large amounts of time and effort are required to visit web sites operating each search engine and to repeatedly re-input the same keyword.

Meanwhile, with the development of the Internet, users use foreign search engines as well as domestic search engines in order to search for desired information. However, when the user does not understand his/her own language's grammar, such as orthographical rules, spacing words, etc., or when the user does not understand the search engine's characteristics and the search method of a site to be searched, the user can search only for restricted information. Especially, since contents of foreign search engines and searched foreign web sites are written in foreign languages, the user who cannot understand a corresponding language very well must translate keywords one by one into the corresponding language before performing a search in order to obtain information through foreign search engines and foreign web sites. Also, in this case, since the result of searched web sites are provided in foreign languages, it is actually difficult to expect even to make an attempt to search foreign web sites, without separately translating the resultant.

Moreover, since the operating systems of computers are different from the language systems of countries, it is impossible even to input the letters of the Chinese language, the Japanese language, etc. unless a separate letter input device is installed.

### DISCLOSURE OF INVENTION

### Technical Problem

Therefore, the present invention has been made in view of the above-mentioned problems, and an object of the present invention is to provide an apparatus and method for an integration search of web sites, which can consecutively search a list of pre-registered search channels using a first keyword input by the user, even without inputting the first keyword in target search engines to be searched one by one.

Another object of the present invention is to provide an apparatus and method for an integration search of web sites, which analyze a morpheme of the first keyword and search a selected search engine using a second keyword generated through the analysis, thereby finding more contents more accurately as a result of the search.

Still another object of the present invention is to provide an apparatus and method for an integration search of web sites, which enable a keyword input and a search a search engine using the keyword to be implemented through a browser, so that a plurality of searched sites can be generated in the form of tabs through the browser.

Still another object of the present invention is to provide an apparatus and method for an integration search of web sites, which translate the second keyword obtained through the analysis into a foreign language so that it is possible to search a search list of foreign sites using a third keyword corresponding to the second keyword.

Still another object of the present invention is to provide an apparatus and method for an integration search of web sites, which receive results of the search using the third keyword and provide the results in the user's own language through web translation, thereby enabling even the user, who cannot understand a foreign language, to search foreign web sites.

### Technical Solution

In order to achieve the above-mentioned object, there is provided an apparatus for an integration search of web sites, the apparatus including: a key input unit for inputting a first keyword to search for information through at least one search engine; a keyword analyzer for performing morpheme analysis of the input first keyword; a keyword generator for generating a second keyword reconstructed through the morpheme analysis, and adding an automatic execution instruction to the second keyword, the automatic execution instruction setting the second keyword to be automatically input in an input window of the search engine upon accessing the selected search engine; and a keyword transmitter for receiving the second keyword, to which the automatic execution instruction has been added, transmitting the second keyword including the automatic execution instruction through at least one output browser to a search engine selected by a user, and displaying searched information which is detected through the transmission.

Preferably, the keyword analyzer determines whether a required search corresponds to a search for information or a search for a specific site/homepage by analyzing the input first keyword.

Preferably, the web-site integration search apparatus further includes: a keyword translation unit for translating the first keyword, which has been subjected to the morpheme analysis, into a foreign language when the selected search engine corresponds to a foreign web site; an output data converter for converting the displayed searched information into a text form, and storing the converted information; a web translation unit for translating the converted data in the text form; and a web-translated data output unit for outputting the data subjected to the translation by the web translation unit to the output browser, thereby displaying the searched information in a translated form, wherein the keyword generator further has functions of generating a third keyword by performing translation into a foreign language through the keyword translation unit and adding the automatic execution instruction to the generated third keyword.

According to another aspect of the present invention, there is provided a method for an integration search of web sites, the method including the steps of: (A) inputting a first keyword in a keyword input window, and selecting one of multiple set search engines or all the set search engines; (B) performing morpheme analysis of the input first keyword; (C) generating a second keyword reconstructed through the morpheme analysis; (D) adding an automatic execution instruction which sets the second keyword to be automatically input in an input window of the selected search engine; and (E) receiving the second keyword, to which the automatic execution instruction has been added, transmitting the second keyword including the automatic execution instruction to a selected search engine through at least one output browser, and displaying searched information which is detected through the transmission.

Preferably, step (A) includes the steps of: selecting one among a domestic-portal search engine, a foreign-portal search engine, and a custom-made search engine, which are main categories; when the domestic-portal search engine has been selected as a result of the main category selection, selecting one among domestic-portal search engines preset as subcategories; when the foreign-portal search engine has been selected as a result of the main category selection, selecting one among foreign-portal search engines which have been preset as subcategories according to respective languages of countries; when the custom-made search engine has been selected as a result of the main category selection, and there are custom-made search engines which have been generated and defined as sub categories by a user, selecting one among the custom-made search engines; and when the custom-made search engine has been selected as a result of the main category selection, and either there is no generated custom-made search engine or a new custom-made search engine is to be generated, defining a search key of interest of the user as a main category by inputting the search key, searching for and defining a plurality of search engines from which information can be search for based on the input search key according to each of multiple pre-registered libraries, selecting at least one of the libraries, and selecting and defining at least one of multiple search engines defined in the selected library as subcategories.

Preferably, step (B) includes a step of analyzing whether the first keyword aims at finding information or finding a specific site/homepage.

Preferably, step (D) includes the steps of: when all the search engines have been selected in step (A), transmitting the second keyword with the automatic execution instruction added thereto to all the search engines; automatically pasting the second keyword on a corresponding web page of each search engine; searching, by the search engine, for information provision servers corresponding to the input second keyword according to the automatic execution instruction; and implementing the respective search engines having results of searching for the information provision servers in a form of tabs in one browser.

Preferably, step (D) includes the steps of: copying the generated second keyword; automatically performing a paste operation of the second keyword when a corresponding web page of the selected search engine is first opened; and searching, by the search engine, for information provision servers corresponding to the input second keyword through an automatic enter instruction.

Preferably, the web-site integration search method includes the steps of: (a) when the selected search engine corresponds to a foreign-portal search engine, translating the first keyword, which has been subjected to the morpheme analysis, into a foreign language, thereby generating a third keyword; (b) adding an automatic execution instruction which sets the third keyword to be automatically input in an input window of the selected search engine upon accessing the selected search engine; (c) converting searched information, which is detected through the selected search engine based on the third keyword, into a text form, and storing the converted information; (d) translating the converted data in the text form; and (e) outputting the data subjected the translation to the output browser, thereby displaying the searched information in a translated form.

Preferably, in step (a), the translation is performed in units of word-phrases or sentences by means of a foreign language dictionary and so on, based on morphemes which are defined in restricted forms called index terms.

### Advantageous Effects

As described above, the apparatus and method for an integration search of web sites according to the embodiments of the present invention have the following effects.

First, when the user searches a plurality of search engines using the same keyword, it is possible to consecutively utilize the search engines by registering the keyword in a list of search engines in advance, so that the user can easily and rapidly obtain more search results, even without inputting the same keyword in the search engines one by one.

Second, since keyword input and keyword search through search engines are implemented through a browser, it is possible to generate searched information of multiple search engines in a form of tabs in one browser, so that it is not required to open a new browser according to a change in search sites for checking information searched for according to each search site, thereby saving resources and time. In addition, since a plurality of search sites are generated in a form of tabs in one browser, movement between search sites can be rapidly achieved upon a change in search sites.

Third, since the morphemes of a first keyword input by the user are analyzed, and selected search engines are searched using a second keyword generated through the analysis, a search using the second keyword generated through the morpheme analysis is performed in addition to a search using the first keyword, so that it is possible to perform the search to obtain a better result through multiple keyword, and so that it is possible to obtain more contents more accurately as a result of the search.

Fourth, since a keyword input in a user's domestic language is translated into a foreign language and is searched for, it is possible to easily search for information in foreign web sites. In addition, since output contents are translated into the user's domestic language and are provided, the user can easily and efficiently search for information written in a foreign language, even if the user cannot understand the foreign language.

Fifth, a provider can easily provide more contents, even without a separate translation web database for a domestic language or a foreign language which is implemented therein, and it is possible to achieve an efficient information search in various types of wireless Internet as well as in online systems.

### BRIEF DESCRIPTION OF THE DRAWINGS

FIG. 1 is a block diagram schematically illustrating the configuration of an entire system including a web-site integration search apparatus according to an exemplary embodiment of the present invention;

FIG. 2 is a block diagram illustrating the configuration of a web-site integration search apparatus according to an exemplary embodiment of the present invention;

FIG. 3 is a flowchart illustrating a web-site integration search method according to an exemplary embodiment of the present invention;

FIGS. 4 and 5 are views illustrating output browser screens for showing results of a web-site integration search according to an exemplary embodiment of the present invention; and

FIGS. 6 to 10 are views illustrating browser screens for explaining the web-site integration search according to an exemplary embodiment of the present invention.

### REFERENCE NUMERALS OF SEVERAL ELEMENTS IN DRAWINGS

100: Web-Site Integration Search Apparatus
110: Keyword Input Unit
120: Keyword Analyzer
130: Keyword Generator
140: Keyword Transmitter
150: Translation Unit
152: Keyword Translation Unit
154: Web Translation Unit
160: Output Data Converter
170: Web-Translated Data Output Unit
180, 190: Output Browser
200: Search Engine
300: Information Provision Server
400: Main Category Of Search Engine
500: Subcategory Of Search Engine
600: Input Window
700a: All-Search Icon
700b: Advanced Search Icon
800: Tab

### BEST MODE FOR CARRYING OUT THE INVENTION

These and other objects of the invention, as well as many of the intended advantages thereof, will become more readily apparent when reference is made to the following description taken in conjunction with the accompanying drawings.

Hereinafter, the apparatus and method for an integration search of web sites according to exemplary embodiments of the present invention will be described with reference to the accompanying drawings. The scope of the present invention is not limited to the embodiments disclosed in the specification and the present invention can be realized in various types. The described present embodiments are presented only for completely disclosing the present invention and helping those skilled in the art to completely understand the scope of the present invention.

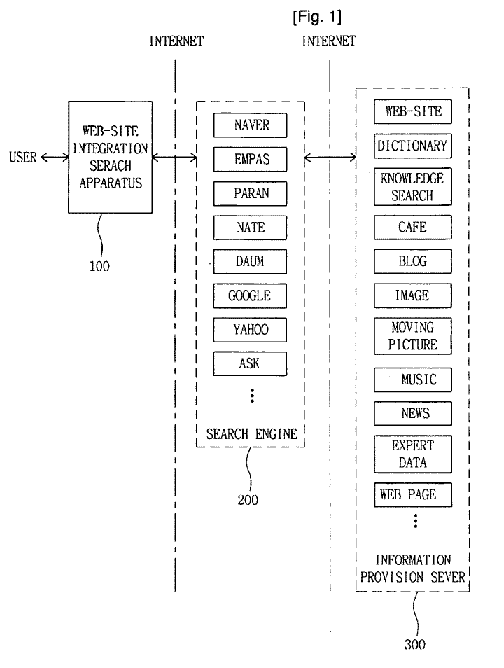

FIG. 1 is a block diagram schematically illustrating the configuration of an entire system including a web-site integration search apparatus according to an exemplary embodiment of the present invention. The system includes a web-site integration search apparatus 100, search engines 200, and information provision servers 300, all of which are connected to each other through the Internet.

The search engines 200 refer to web sites, such as NAVER, DAUM, EMPAS, NATE, YAHOO, GOOGLE, PARAN, ASK, etc., which help users to search for sites including information desired by the users. The search engines 200 are classified into domestic-portal search engines (e.g. NAVER, EMPAS, PARAN, NATE, DAUM, GOOGLE KOREA, YAHOO KOREA, etc.) and foreign-portal search engines (e.g. such as GOOGLE, YAHOO, ASK AND ALTAVISTA in English-speaking countries; BAIDO, SOHU.COM, QQ.COM AND SINA.COM in Chinese-speaking countries; GOOGLE.CO.JP, GOO.NE.JP, EXCITE.CO.JP in Japanese-speaking countries; etc.).

The information provision servers 300 refer to servers which store information, such as web sites, dictionaries, knowledge search, Internet cafes, blogs, images, moving pictures, music, news, expert data, web pages, etc., which users desire through a search using the search engines 200.

Therefore, the web-site integration search apparatus 100 generates a second keyword through keyword analysis (e.g. morpheme analysis) of a first keyword input to the apparatus 100, and transmits the second keyword to pre-registered search engines 200. Then, one or more information provision servers 300 corresponding to the second keyword are automatically searched for through a search engine 200 selected by the user, and are then provided to the user. For reference, the user may select all the registered search engines 200, or may select only one of the search engines 200.

Also, when a search engine 200 selected by the user necessitates a foreign language keyword, the web-site integration search apparatus 100 generates a third keyword by translating the input first keyword into a corresponding foreign language, which is requested by the user or required for the selected search engine 200. Then, information provision servers 300 corresponding to the third keyword are automatically searched for through the selected search engine 200, and are then provided to the user. In this case, the web-site integration search apparatus 100 translates searched information provided by the automatically-searched information provision servers 300 into a language requested by the user, and provides the translated information to the user.

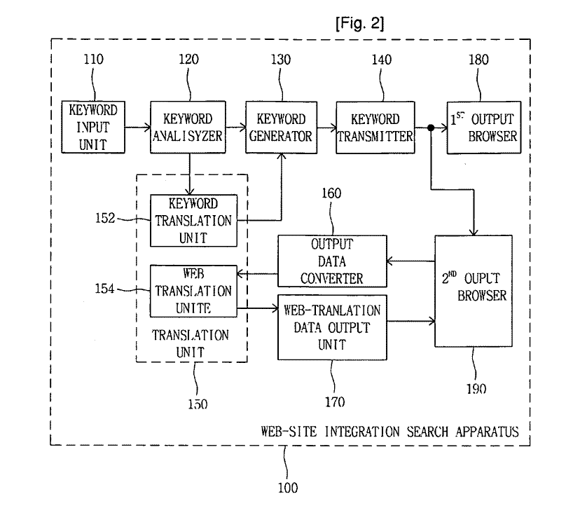

FIG. 2 is a block diagram illustrating the configuration of a web-site integration search apparatus according to an exemplary embodiment of the present invention.

As shown in FIG. 2, the web-site integration search apparatus includes a keyword input unit 110 for providing an input window 600 so that the user can input a first keyword to search for desired information through a selected search engine 200, and a keyword analyzer 120 for analyzing the first keyword so that a grammatical function of the first keyword input through the keyword input unit 110 can be recognized through morpheme analysis. In addition, the keyword analyzer 120 determines whether the first keyword aims at finding information or finding a specific site or homepage through the search engine 200. That is, when the input first keyword which has been input corresponds to a sentence or a specific technology, there is a high likelihood that the user desires information according to the sentence or specific technology. In contrast, when the input first keyword which has been input corresponds to a company name (e.g. Samsung Electronics, Sony, etc.) or a specific product name (e.g. pizza, MP3, etc.), there is a high likelihood that the user desires to search for the homepage of a corresponding company or for a shopping mall selling a corresponding product, rather than information according thereto. Therefore, the keyword analyzer 120 determines if the first keyword corresponds to any one of the two cases.

Since it is necessary to translate a keyword into a foreign language when the search engine 200 selected by the user corresponds to a foreign web site, the web-site integration search apparatus includes a keyword translation unit 152 for translating the first keyword, the morpheme of which has been analyzed, into foreign languages. In addition, the web-site integration search apparatus includes a keyword generator 130 and a keyword transmitter 140. The keyword generator 130 generates a second keyword reconstructed through morpheme analysis by the keyword analyzer 120, or generates a third keyword obtained through translation into a foreign language by the keyword translation unit 152. The keyword transmitter 140 receives the second or third keyword, accompanied by an automatic execution instruction recorded therein, from the keyword generator 130, transmits the received second or third keyword through a first output browser 180 or a second output browser 190 to the search engine 200 selected by the user, and displays searched information extracted by the search engine 200.

In addition, the web-site integration search apparatus includes an output data converter 160 for converting searched browser page data displayed through the second output browser 190 into a text form and storing the converted browser data, a web translation unit 154 for translating the text-type browser data converted by the output data converter 160 into the user's native language, and a web-translated data output unit 170 for outputting the browser data subjected to the translation into the user's native language by the web translation unit 154 to the second output browser 190 so that searched information can be displayed in a form translated into the user's native language.

In this case, when the selected search engine 200 corresponds to a foreign web site, the keyword input unit 110 enables the user to input a keyword in the language of a country desired by the user, as well as a corresponding foreign language.

It is preferred that the keyword translation unit 152 translates keywords in units of phrases or sentences by means of foreign language dictionaries, and that the web translation unit 154 translates web pages in units of pages by means of an automatic web translator.

Also, the keyword generator 130 records, together with a second keyword or third keyword generated thereby, an execution instruction to automatically execute a search through the search engine 200 selected by the user simultaneously with the input of the second keyword or third keyword.

The first output browser 180 displays information provision servers 300 searched by the corresponding search engine 200 as they are, and the second output browser 190 displays information provision servers 300 searched using a keyword which has been converted through the web-site integration search apparatus. Here, only any one of the first output browser 180 and second output browser 190 may be displayed on a screen according to the user's selection.

A web-site integration search method by the aforementioned web-site integration search apparatus according to an exemplary embodiment of the present invention will now be described in detail with reference to the accompanying drawings.

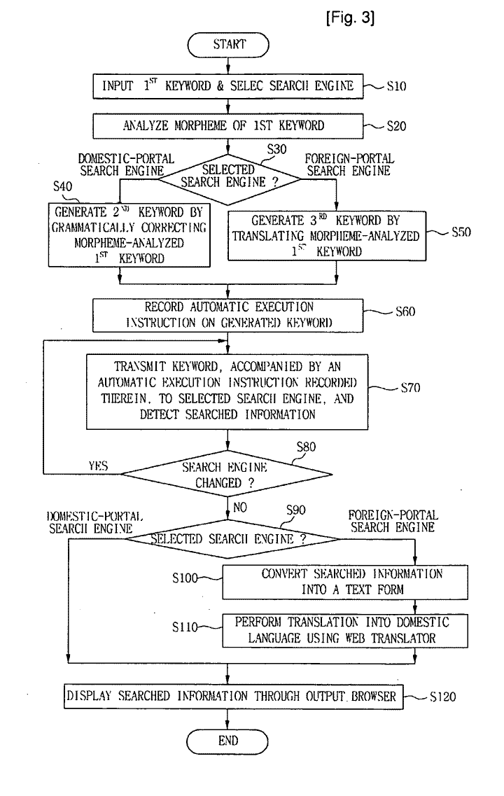

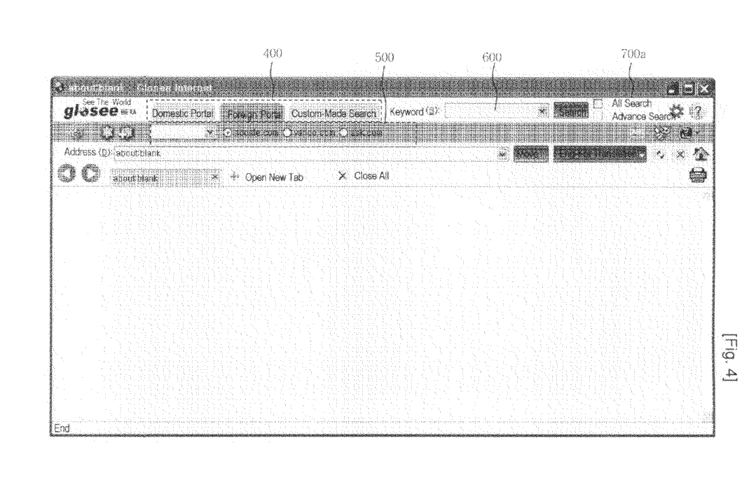

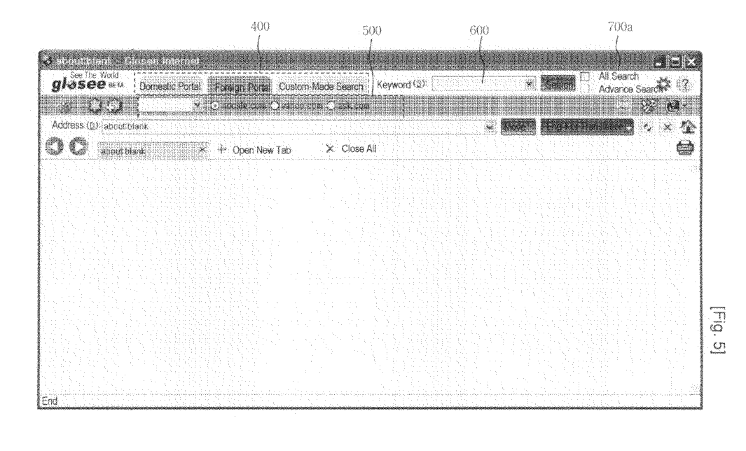

FIG. 3 is a flowchart illustrating a web-site integration search method according to an exemplary embodiment of the present invention, and FIGS. 4 and 5 are views illustrating output browser screens for showing results of a web-site integration search according to an exemplary embodiment of the present invention. Here, FIG. 4 shows a browser screen output when domestic-portal search engines are selected, and FIG. 5 shows a browser screen output when foreign-portal search engines are selected.

Referring to FIG. 3, first, the user inputs a first keyword for searching for desired information in the keyword input unit 110, and selects one of multiple preset search engines or all preset search engines (step 10). For reference, the reason why all the search engines can be selected is that keyword input and search performance are implemented through a browser, and a plurality of search engines can be generated in one browser.

In this case, in order to select the search engine 200, the user first selects any one of domestic-portal and foreign-portal search engines 400, which are main categories.

Next, when the user is to select one search engine, the user selects any one among search engines 500, which are established as subcategories according to each of the domestic-portal search engines and foreign-portal search engines. That is, when the domestic-portal search engine 400 has been selected, as shown in FIG. 4, the user selects any one among NAVER, EMPAS, PARAN, NATE, DAUM, GOOGLE KOREA, YAHOO KOREA, etc. 500, which have been preset as subcategories of the domestic-portal search engine. Also, when the foreign-portal search engine 400 has been selected, as shown in FIG. 5, the user selects any one among sites (e.g. such as GOOGLE, YAHOO, ASK AND ALTAVISTA in English-speaking countries; SOHU.COM, QQ.COM AND SINA.COM in Chinese-speaking countries; GOOGLE.CO.JP, GOO.NE.JP, EXCITE.CO.JP in Japanese-speaking countries; etc.), which have been preset as subcategories of the foreign-portal search engine. In contrast, when the user is to select all search engines, the user selects an all-search icon 700a for a search through all search engines, which is displayed at one side in the screen.

Accordingly, the first page of a selected search engine is displayed through the first output browser 180 and the second output browser 190.

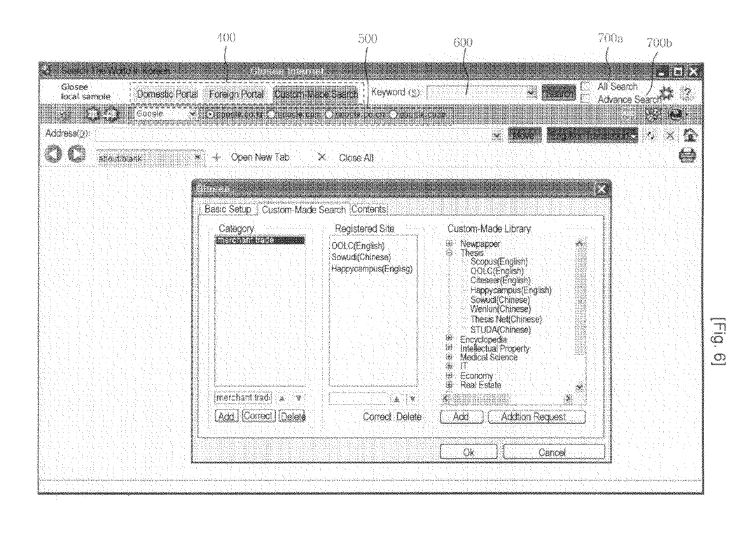

Also, defined contents of the main categories 400 of classifying search engines according to domestic and foreign portals, and defined contents of the subcategories 500 of classifying search engines according to each main category may be newly implemented in a custom-made form. That is, as shown in FIG. 6, the user may select a custom-made search 400, generated together with the domestic portal and foreign portal 400, and define a main category by inputting a keyword desired by the user through a pop-up window. Then, the web-site integration search apparatus 100 searches for multiple search engines, from which information related to the input keyword can be found, according to each pre-registered library (e.g. newspaper, thesis, encyclopedia, Intellectual Property, medical science, IT, economy, real estate, taxation, environments, image, religion, etc.), and provides the searched search engines.

Therefore, after defining the main category (e.g. a merchant trade), the user selects one (e.g. thesis) among the custom-made search libraries provided to define sub-categories, and selects at least one among search engines (e.g. Scopus (English), OOLC (English), Citeseer (English), Happy campus (English), Sowudi (Chinese), Wenlum (Chinese), Thesis.net (Chinese), STUDA (Chinese)), which are provided as subcategories in the selected custom-made search library (i.e. thesis), thereby determining custom-made subcategories defined by the user.

As described above, the custom-made search engine has an advantage in that the user can easily search information of various fields, such as thesis, economy, newspaper, etc., depending on the definition thereof, as well as domestic portals and foreign portals.

For reference, the user may define a specific search engine as the first page so that the specific search engine can be opened as the first page whenever the user accesses the web-site integration search apparatus 100 for the first time.

Next, when the user has input the first keyword to search for desired information in the keyword input unit 110, and has selected a search engine, the web-site integration search apparatus performs morpheme analysis on the first keyword through the keyword analyzer 120 (step 20). For reference, Korean is an agglutinative language in which a word-phrase, that can be regarded as a unit of sentence, is constituted by a combination of lexical morphemes and grammatical morphemes, and the grammatical morpheme has characteristics of indicating a grammatical function in a sentence. Therefore, in order to identify the grammatical function of a word in a sentence, a task of dividing a word-phrase in units of morphemes must first be performed. This is a necessary step in not only machine translation and information search, but also in any other applications based on the processing of Korean. Here, since the minimum unit required for the analysis is a morpheme, the analysis is called “morpheme analysis.” Since the morpheme analysis method is widely known, a detailed description thereof will be omitted.

Then, the keyword analyzer 120 determines which search engine has been selected in the above step by the user, and determines whether the first keyword aims at finding information or finding a specific site or homepage through the search engine 200 (step 30).

When it is determined that the user has selected a domestic-portal search engine, as a result of the search engine determination in step 30, the web-site integration search apparatus generates a second keyword which is grammatically corrected through morpheme analysis by the keyword generator 130 (step 40). That is, when the user inputs A grandmother enters a room. without word spacing as the first keyword, which may be interpreted in Korean as the meaning of “A grandmother enters a bag,” the keyword generator 130 analyzes the morphemes of the first keyword, and generates A grandmother enters a room. with correct word spacing as a second keyword. For reference, the grammatical conversion into the second keyword through morpheme analysis is not restricted to spacing words. That is, it should be noted that the word spacing is an embodiment for convenience of description, and the present invention is not limited thereto.

As described above, the input first keyword is subjected to a morpheme analysis, and the second keyword generated through the analysis is used for a search through selected search engines, so that it is possible to obtain more contents more accurately as a result of the search than when only the first keyword input by the user is used. For reference, the method of performing a search using a second keyword is optional, and a first keyword input by the user may be used, as it is, depending on the user's selection to perform a search through a selected search engine. Such a scheme is controlled through the selection of an advanced search icon 700b formed at one side on the screen.

Meanwhile, when it is determined that the user has selected a foreign-portal search engine, as a result of the search engine determination in step 30, the web-site integration search apparatus generates translates the first keyword, which has been subjected to the morpheme analysis, into a foreign language for the selected foreign-portal search engine through the keyword translation unit 152 of the translation unit 150, and then generates a keyword translated into the foreign language as a third keyword through the keyword generator 130 (step 50). This is because, when the search engine 200 is a foreign web site, a keyword to be used for a search must be constituted by a corresponding foreign language. In this case, it is preferred that the keyword translation unit 152 translates the first keyword based on morphemes defined in restricted forms, which are called index terms, through word-phrase or sentence translation using a foreign language dictionary or the like.

Next, the keyword generator 130 performs an operation such that the generated second or third keyword to be automatically input in the keyword input window of the search engine 200 selected by the user, and an automatic execution instruction for automatically executing the search is recorded together with the second or third keyword (step 60).

The automatic execution instruction may be implemented, for example, as follows.

Every search engine 200 has been set such that its input cursor can be located in its own keyword input window when the web page of the search engine 200 is first opened. Therefore, by a program, an operation of copying the generated second or third keyword is first performed, and an operation of pasting the second or third keyword at the same time is performed at the same time when a corresponding web site is opened. As a result, since an input cursor is located in a keyword input window within the opened web page, the copied second or third keyword is pasted in the keyword input window by the paste instruction. Next, according to a preset program, an enter instruction is performed, so that the search engine records an automatic execution instruction to search for information provision servers 300 corresponding to the second or third keyword.

In this case, when any one (e.g. a first search engine) of multiple search engines has been selected in step 10, the keyword transmitter 140 transmits the second or third keyword, with an automatic execution instruction recorded by the keyword generator 130, to the first search engine 200. Then, the first search engine 200 detects contents searched from the information provision servers 300 by searching information providers contents of the information provision servers 300 using the transmitted second or third keyword (step 70).

Then, when the user changes his/her selection by selecting a second search engine 200 different from the first search engine 200 (step 80), the second or third keyword is transmitted to the second search engine 200 through the first output browser 180 and second output browser 190 in the same way as described above, so that the second search engine 200 searches for and detects information (step 70).

Accordingly, when the user consecutively changes his/her selection from one search engine 200 to another search engine 200 while performing a search of each web site using the same keyword, it is possible to consecutively detect searched information, even without re-inputting the same keyword at every web site, thereby enabling the user to easily and rapidly search for information.

Meanwhile, when all search engines have been selected in step 10, the keyword transmitter 140 transmits the second or third keyword, with an automatic execution instruction recorded by the keyword generator 130, to all the search engines 200. Then, each search engine 200 detects contents searched from the information provision servers 300 by searching information providers contents of the information provision servers 300 using the transmitted second or third keyword (step 70). For reference, the reason why all the search engines can be selected is that keyword input and search performance are implemented through a browser, and a plurality of search engines can be generated in one browser.

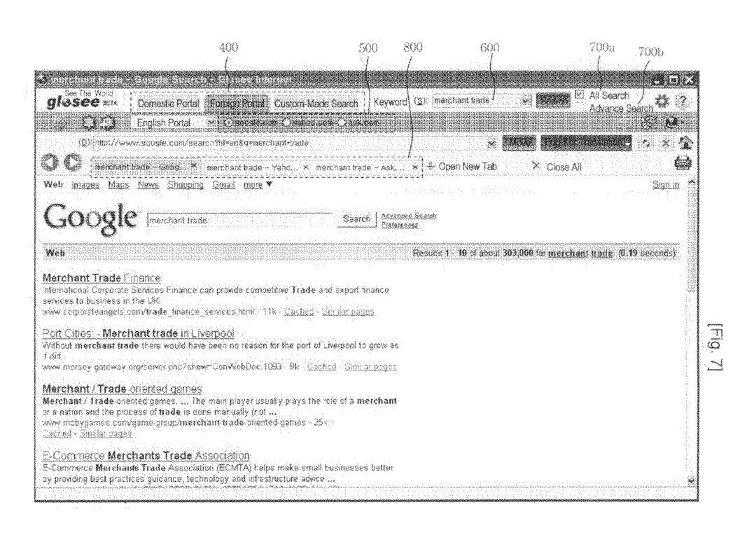

Therefore, as shown in FIG. 7, information searched by multiple search sites is implemented in the form of tabs through the browser. When the user changes his/her selection from a selected first search engine 200 to a second search engine 200 by selecting a tab for the second search engine 200, using tabs 800 implemented according to search sites (step 80), contents searched through the second search engine 200 are detected through the first output browser 180 and second output browser 190 in the same way as described above (step 70). When information searched by multiple search sites is generated in the form of tabs in one browser, as described above, movement between search sites can be rapidly achieved because of a state where all the search engines have completed their respective information searches.

Also, when the search engine 200 selected by the user corresponds to a domestic-portal search engine (step 90), searched information which the search engine detects through at least one of the first output browser 180 and second output browser 190 using the second keyword (domestic language) is displayed (step 120).

In contrast, when the search engine 200 selected by the user corresponds to a foreign-portal search engine (step 90), searched information which the search engine detects through at least one of the first output browser 180 and second output browser 190 using the third keyword (foreign language) is converted into a text form through the output data converter 160, is stored, and is then transmitted to the web translation unit 154 (step 100).

Then, the web translation unit 154 translates the received text-type data into the domestic language (step 110). In this case, the translation generally represents translating a foreign language into a domestic language, but the translation may be performed into another language as required by the user. For reference, it is preferred that the translation is performed in units of pages by means of an automatic web translator (not shown).

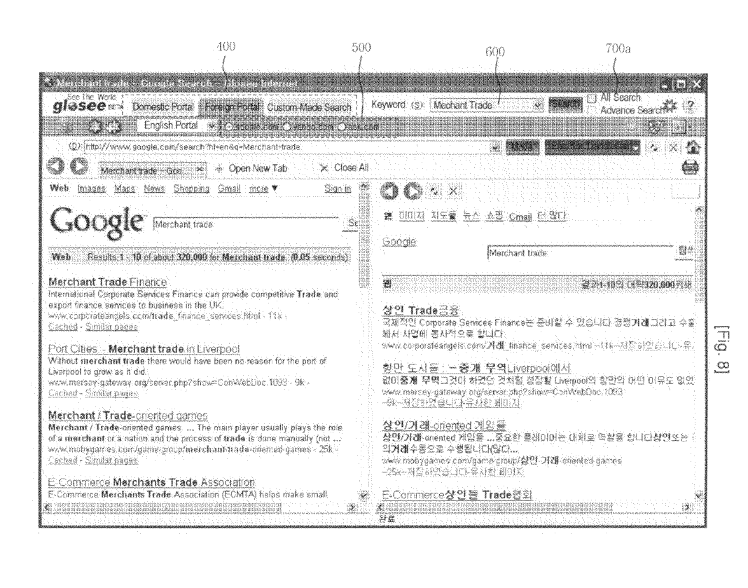

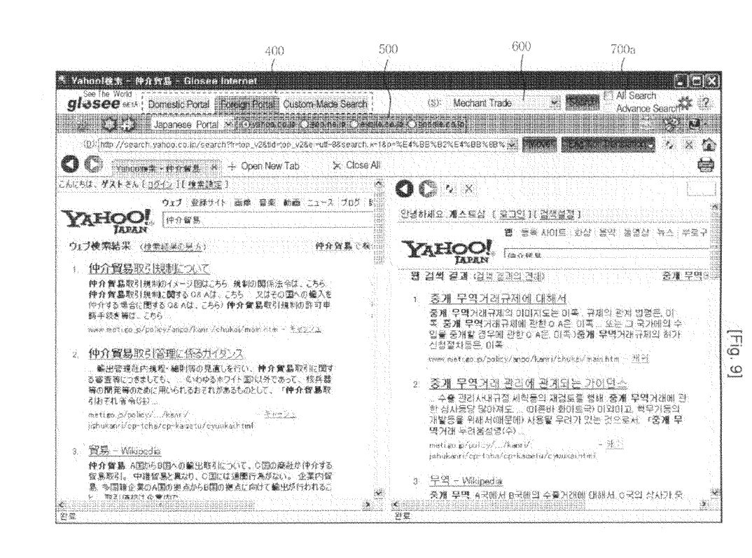

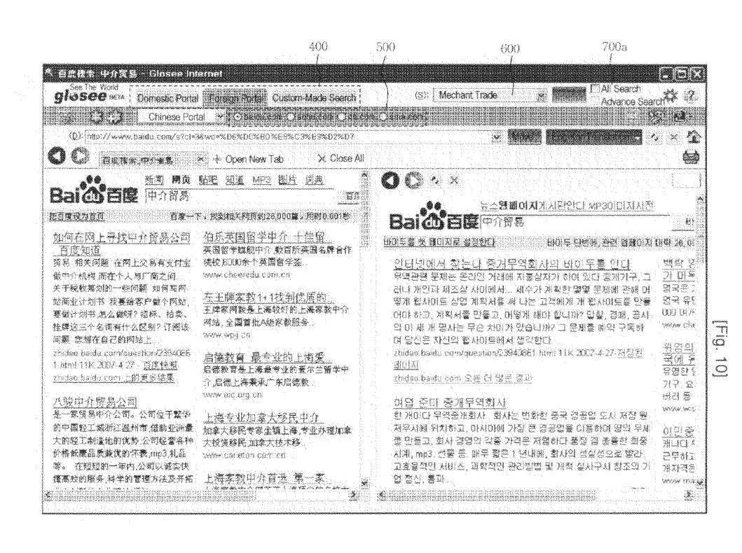

The data subjected to the translation into the domestic language by the translation unit 150, as described above, is output to the second output browser via the web-translated data output unit 170, so that searched information detected in a foreign language by the search engine is displayed in the form translated into the domestic language (step 120). FIG. 8 shows an example where English is translated into Korean, FIG. 9 shows an example where Japanese is translated into Korean, and FIG. 10 shows an example where Chinese is translated into Korean.

Meanwhile, only any one of the first output browser 180 and second output browser 190 may be displayed on the screen according to the user's selection (step 120).

Accordingly, searched foreign-language-based contents provided through foreign sites are provided to the user through a browser in the form translated into his/her domestic language, so that the user can easily search even information provided by the foreign sites, and can easily acquire desired information from the foreign sites.

Meanwhile, when it is determined in step 30 that the user has selected to search for a specific site or homepage, a searched specific site or homepage is displayed through the first output browser 180 and second output browser 190.

### INDUSTRIAL APPLICABILITY

Although the technical aspects of the present invention have been described with the exemplary embodiments of the present invention, it should be appreciated that the embodiments described above are not limitative, but only illustrative. In addition, those skilled in the art will appreciate that various embodiments are possible, without departing from the technical aspects of the present invention. Accordingly, the scope of the present invention must be defined by the technical aspects of the appended claims.

1-19. (canceled)

20. An apparatus for an integration search of web sites, the apparatus comprising:
a key input unit for inputting a first keyword to search for information through at least one search engine;
a keyword analyzer for performing morpheme analysis of the input first keyword;
a keyword generator for generating a second keyword reconstructed through the morpheme analysis, and adding an automatic execution instruction to the second keyword, the automatic execution instruction setting the second keyword to be automatically input in an input window of the search engine upon accessing the selected search engine; and
a keyword transmitter for receiving the second keyword, to which the automatic execution instruction has been added, transmitting the second keyword including the automatic execution instruction through at least one output browser to a search engine selected by a user, and displaying searched information which is detected through the transmission.

21. The apparatus as claimed in claim 20, wherein the keyword analyzer determines whether a required search corresponds to a search for information or a search for a specific site/homepage by analyzing the input first keyword, and displays the specific site/homepage through the output browser when it is determined that the required search corresponds to the search for the specific site/homepage as a result of the analysis.

22. The apparatus as claimed in claim 20, wherein the automatic execution instruction sets a search for an information provision server according to the second keyword to be automatically performed through the search engine after the second keyword has been automatically input to the search engine.

23. The apparatus as claimed in claim 20, further comprising:
a keyword translation unit for translating the first keyword, which has been subjected to the morpheme analysis, into a foreign language when the selected search engine corresponds to a foreign web site;
an output data converter for converting the displayed searched information into a text form, and storing the converted information;
a web translation unit for translating the converted data in the text form; and
a web-translated data output unit for outputting the data subjected to the translation by the web translation unit to the output browser, thereby displaying the searched information in a translated form,
wherein the keyword generator further has functions of generating a third keyword by performing translation into a foreign language through the keyword translation unit and adding the automatic execution instruction to the generated third keyword.

24. The apparatus as claimed in claim 23, wherein the keyword translation unit performs translation in units of word-phrases or sentences by means of a foreign language dictionary and so on.

25. The apparatus as claimed in claim 23, wherein the web translation unit performs translation in units of pages by means of a web translator.

26. The apparatus as claimed in claim 23, wherein the output browser comprises:
a first output browser for displaying information searched by the selected search engine as it is; and
a second output browser for displaying searched information which is obtained by translating the searched information displayed on the first output browser by means of the web translation unit.

27. A method for an integration search of web sites, the method comprising the steps of:
(A) inputting a first keyword in a keyword input window, and selecting one of multiple set search engines or all the set search engines;
(B) performing morpheme analysis of the input first keyword;
(C) generating a second keyword reconstructed through the morpheme analysis;
(D) adding an automatic execution instruction which sets the second keyword to be automatically input in an input window of the selected search engine; and
(E) receiving the second keyword, to which the automatic execution instruction has been added, transmitting the second keyword including the automatic execution instruction to a selected search engine through at least one output browser, and displaying searched information which is detected through the transmission.

28. The method as claimed in claim 27, wherein step (A) comprises the steps of:
selecting one among a domestic-portal search engine, a foreign-portal search engine, and a custom-made search engine, which are main categories;
when the domestic-portal search engine has been selected as a result of the main category selection, selecting one among domestic-portal search engines preset as subcategories;
when the foreign-portal search engine has been selected as a result of the main category selection, selecting one among foreign-portal search engines which have been preset as subcategories according to respective languages of countries;
when the custom-made search engine has been selected as a result of the main category selection, and there are custom-made search engines which have been generated and defined as sub categories by a user, selecting one among the custom-made search engines; and
when the custom-made search engine has been selected as a result of the main category selection, and either there is no generated custom-made search engine or a new custom-made search engine is to be generated, defining a search key of interest of the user as a main category by inputting the search key, searching for and defining a plurality of search engines from which information can be search for based on the input search key according to each of multiple pre-registered libraries, selecting at least one of the libraries, and selecting and defining at least one of multiple search engines defined in the selected library as subcategories.

29. The method as claimed in claim 28, wherein the libraries include at least one among newspaper, thesis, encyclopedia, Intellectual Property, medical science, IT, economy, real estate, taxation, environments, image, and religion.

30. The method as claimed in claim 28, wherein the subcategories can be changed by the user.

31. The method as claimed in claim 27, wherein step (B) comprises a step of analyzing whether the first keyword aims at finding information or finding a specific site/homepage.

32. The method as claimed in claim 27, wherein step (D) comprises the steps of:
when all the search engines have been selected in step (A), transmitting the second keyword with the automatic execution instruction added thereto to all the search engines;
automatically pasting the second keyword on a corresponding web page of each search engine;
searching, by the search engine, for information provision servers corresponding to the input second keyword according to the automatic execution instruction; and
implementing the respective search engines having results of searching for the information provision servers in a form of tabs in one browser.

33. The method as claimed in claim 27, wherein step (D) further comprises a step of setting a search for an information provision server according to the second keyword to be automatically performed through the search engine after the second keyword has been automatically input.

34. The method as claimed in claim 27, wherein step (D) comprises the steps of:
copying the generated second keyword;
automatically performing a paste operation of the second keyword when a corresponding web page of the selected search engine is first opened; and
searching, by the search engine, for information provision servers corresponding to the input second keyword through an automatic enter instruction.

35. The method as claimed in claim 27, wherein, for the displayed first page, a specific search engine is pr-defined as a first page, and the preset search engine is opened as the first page whenever an access to a web-site integration search apparatus is first generated.

36. The method as claimed in claim 27, further comprising the steps of:
(a) when the selected search engine corresponds to a foreign-portal search engine, translating the first keyword, which has been subjected to the morpheme analysis, into a foreign language, thereby generating a third keyword;
(b) adding an automatic execution instruction which sets the third keyword to be automatically input in an input window of the selected search engine upon accessing the selected search engine;
(c) converting searched information, which is detected through the selected search engine based on the third keyword, into a text form, and storing the converted information;
(d) translating the converted data in the text form; and
(e) outputting the data subjected the translation to the output browser, thereby displaying the searched information in a translated form.

37. The method as claimed in claim 36, wherein, in step (a), the translation is performed in units of word-phrases or sentences by means of a foreign language dictionary and so on, based on morphemes which are defined in restricted forms called index terms.

38. The method as claimed in claim 36, wherein, in step (d), the translation is performed in units of pages by means of a web translator.
